(19) United States
(12) Patent Application Publication
(10) Pub. No.: US 2007/0078666 A1
(43) Pub. Date: Apr. 5, 2007

(54) Method and system for development of on-campus facilities beneficial to institutions utilizing private capital subsidies

(76) Inventor: Michael A. Mouron, (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/213,488

(22) Filed: Aug. 26, 2005

(51) Int. Cl. G06Q 99/00

(52) U.S. Cl. 705/1

(57) ABSTRACT

A method of financing and/or managing development of property located on institution-owned real estate is provided, which provides the institution with one or more improvement facilities in exchange for only periodic, limited term specialty use and occupancy rights in the developed facility, allowing use by the institution outside of the periodic use and occupancy periods. This is made possible because land costs have already been absorbed by the institution, and the commercial appeal of the Fieldhouse units will generate surplus funds available for the construction of other facilities beneficial to the institution.

### BACKGROUND OF INVENTION

1. Field of the Invention

The invention relates generally to a business method utilizing University and College owned real estate and private capital to finance, construct and develop physical facilities that benefit the institution without tapping its financial resources.

2. Background Art

It is known that most public and private Universities and Colleges (hereafter collectively referred to as “institutions”) face severe financial challenges because of increasing student populations and facility demands, rising construction costs and shrinking financial support from traditional public and private sources. It is also known in the real estate financing and development industries that a market exists for “Fieldhouse” accommodations in the general vicinity of University and College campuses. A “Fieldhouse” accommodation is a facility, such as a condominium, townhouse or other multi-unit facility, the units of which are developed, marketed, and sold to sports fans (especially alumni and others with close emotional ties to the institution) that have an anticipated residence time and usage pattern that coordinates with the home game schedule of institution sponsored sports teams. Presently, “Fieldhouse” accommodations are limited to locations physically separated from University and College campuses. Such developments and the use thereof are not tied to the best interests of the educational institution, and developmental decisions are often made without regard to potential benefits of coordination or potential pitfalls arising from failure to coordinate. Several areas for improvement have been identified concerning the prior art involving this concept.

### OBJECTS OF THE INVENTION

The following stated objects of the invention are alternative and exemplary objects only, and no one or any should be read as required for the practice of the invention, or as an exhaustive listing of objects accomplished.

In some aspects, advantages of the invention includes providing a method for financing development of real estate and facilities located on institution owned property.

In other aspects, advantages of the invention includes providing a method for generating on-campus improvements that have appreciable value-added benefits, such as increased parking capacity and overnight lodging at times other than specified periods in a sports calendar, with little or no capital outlays from institution financial resources.

In other aspects, advantages of the invention includes providing a method of generating campus improvements with little or no capital outlay from a institution, but with an appreciable value-added benefit, such as use of the improvements for parking or hosting personnel and events at times other than select periods in a sports calendar

In other aspects, advantages of the invention includes providing a real estate financing or development methodology for private leasehold interests located on institution property, that can take advantage of a computerized database and/or Internet connectivity to calculate costs, benefits, and offsets.

In other aspects, advantages of the invention includes providing a real estate financing or development methodology for private leasehold interests located on institution property, that can take advantage of a computerized bidding system to increase leasehold cost based on priority in selection of units, cost paid, or other parameters managed by a computerized interface populated with information regarding the developed property, such as unit location, unit size, unit sale date, and/or a schedule of days during which units may be used by the leaseholder, which may vary in terms of available days before and available days after a given event or type of event scheduled on-campus.

The above objects and advantages are neither exhaustive nor individually critical to the spirit and practice of the invention, except as stated in the claims as issued. Other alternative objects and advantages of the present invention will become apparent to those skilled in the art from the following description of the invention.

### SUMMARY OF INVENTION

In some aspects, the invention relates to long-term, “Exclusive-Use Leased Residences”. In one embodiment, an institution, such as a state University, leases land to a University-affiliated non-profit foundation for a specified term of years. Each residence or unit lease generates a lease payment, typically though not necessarily fully or partially “up front”, which collectively are first applied to fully fund the cost of development of the on-campus multi-unit improvement, including all related professional fees, and second applied to fully or partially fund the cost of development for a second facility desired by the institution. The institution gains fee title to the multi-unit improvement at the expiration of the ground or air rights lease to the foundation. During the term of the ground or air rights lease, the provisions of the lease can limit the number and schedule of days that a unit sublessee can occupy the unit, or, phrased differently, can specify that except for certain days allocated for use by the sublessee, the improvement is available for use by the institution, free of charge, for purposes to be selected by the institution such as parking, hosting or housing personnel and candidates, lecture use, and the like. In a more specific embodiment, the developer employs computers to select land, calculate profits, generate proposals to the Institution, and/or manage the development in or across one or more of the stages, potentially allowing for minimal institution administrative resources. Other variations are possible, with the scope of the invention limited only by the claims set forth in this patent as ultimately allowed.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a block diagram of an example of campus facilities in accordance with one embodiment of the present invention.

FIG. 2 shows a block diagram of an example of the method in accordance with one embodiment of the present invention.

### DETAILED DESCRIPTION

The following is a detailed exemplary description of an embodiment of the invention, in a number of its various aspects. Those skilled in the art will understand that the specificity provided herein is intended for illustrative purposes with respect to an exemplary embodiment, only, and is not to be interpreted as limiting the scope of the invention or claims.

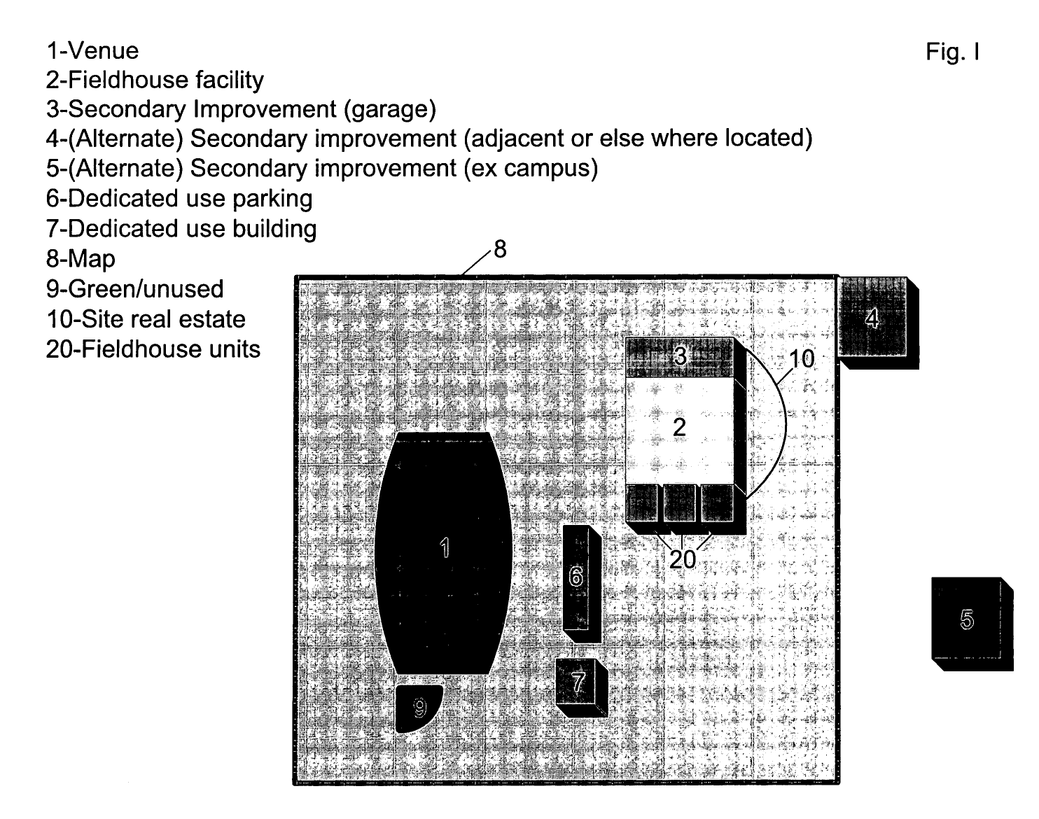

The present invention is described herein with references to the drawings, but the specificity here is provided as exemplary, and shall not be used to limit the scope of the claims as issued. As will be noted in several locations hereinbelow, but without limitation to such specifically designated uses, the methodology can take particular advantage of computerized planning and management in a number of its phases. Starting with reference to FIG. 1, there is shown a mock-up of a campus map 8 of an institution 100. Exemplary of the types of institutions 100 that are contemplated in the methodology herein described are state funded Universities, though any institution having real estate located in the vicinity of a sports venue that hosts sporting events for the institution may be within the scope of this disclosure. As seen from the map 8, an institution 100 typically will have a venue 1, such as a football stadium. The venue 1 is in many cases surrounded by surface parking lots or decked parking facilities designated in the map 8 as dedicated use lots 6. Additionally, institution 100 may have dedicated use buildings 7 already constructed or planned, which may include housing, administration facilities, classrooms, and the like. In consequence, unallocated space 9, such as green fields, quads, and the like may be in short supply but in some cases are maintained for the sake of landscaping or because of lack of funds. For purposes of discussion, map 8 also includes locations adjacent campus real estate designated by example as adjacent lands 4, and even real estate in areas not contiguous to the campus, designated as ex-campus lands 5.

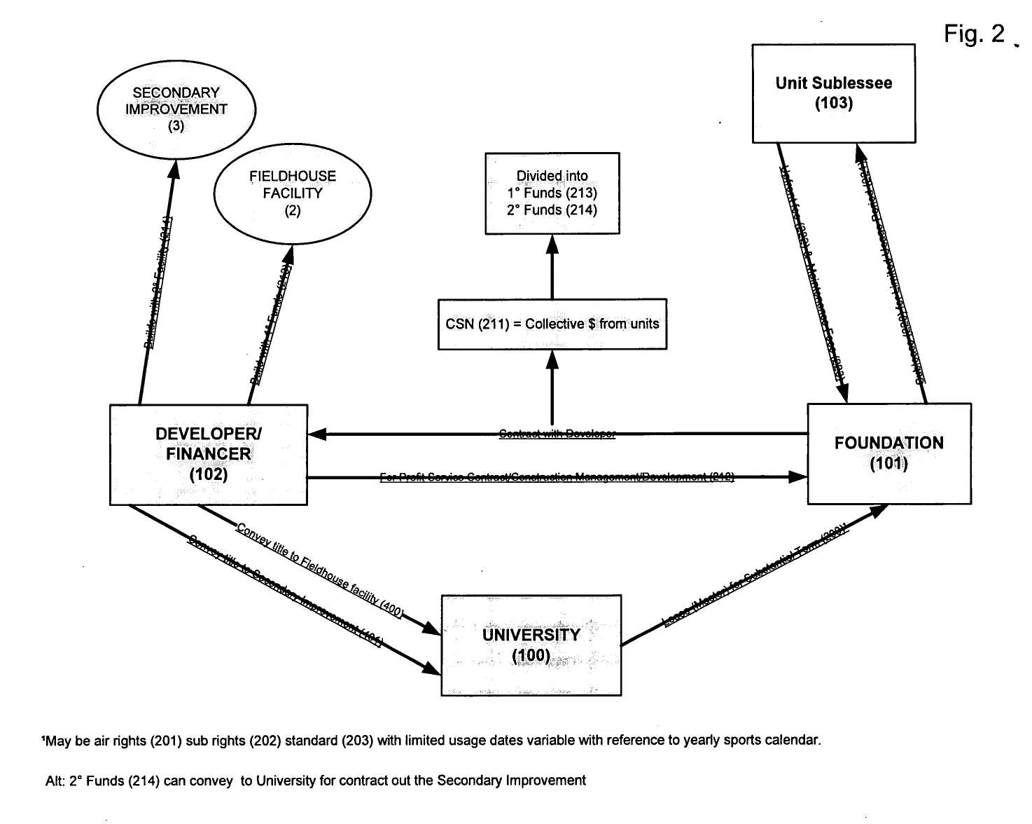

Turning to FIG. 2, the present methodology in one of its exemplary embodiments involves the institution 100, a developer 102, and a Unit Sublessee or “unitholder” 103. In a more particular embodiment, the method also involves a foundation 101, which in the exemplary discussion here is a non-profit or not-for-profit entity. In the embodiment shown in FIG. 2, the institution 100 identifies and makes available a real estate location on-campus, designated on FIG. 1 as site real estate 10, for construction of a Fieldhouse facility 2. In this embodiment, the institution 100 is not required to contribute any funds or undertake any debt in order to finance the construction (though some scenarios could be envisioned within the scope of the invention that would have the institution 100 undertaking some burden). Thus, the contribution or financial outlay of the institution 100 to the development may be as limited as encumbrance for a limited time of site real estate 10. It is to be noted that the institution 100 does not in this embodiment convey title to the site real estate 10, but merely undertakes an encumbrance in the nature of grant of a leasehold or other interest or right in the site real estate 10.

In a particular embodiment of the method, the encumbrance could be limited to “air rights” or “underage rights”. By way of example, where a institution 100 selects as site real estate 10 an existing dedicated use lot 6, the institution could choose to encumber the site real estate only by providing “air rights”, meaning the right to build facilities over the existing (or, even future planned) dedicated use lot 6. This would allow the dedicated use lot 6 to continue in its full pre-existing (or future planned) function without loss of utility or value to the institution 100, while allowing the construction of a multi-unit fieldhouse facility 2 above the lot. In this example, the fieldhouse facility 2 may be a condominium-type facility built over a parking lot to create covered parking, or even incorporating a parking garage in its substructure or foundation. While less often anticipated to be desirable, some site real estate 10 may lend itself to selection of an encumbrance scheme in which the institution 100 grants rights only to construct fieldhouse facilities 2 under (creating “underage rights”) the institution's continued use of facilities. By way of example, the institution 100 may desire to maintain a stadium club, “penthouse” level, or other facility above the fieldhouse facility 2. This also is within the scope of the invention.

In order to accommodate restrictions on disbursement, disposal, or encumbrance of state funds or assets, the method contemplates the optional inclusion of a foundation 101, possibly a non-profit or not-for-profit entity, if that may assist in obtaining or avoiding the need for approval of the encumbrance or satisfy other issues such as marketing. Where a foundation 101 is involved, it is anticipated that the foundation 101 will be granted the encumbrance of the site real estate 10 by the institution 100 (often directly, but by some machinations an indirect transfer or interest could be contemplated within the scope of the invention). That is, the foundation will enjoy the rights of, or right to use, the leasehold, air rights, underage rights, or other encumbrance or grant of rights in the site real estate 10. In this embodiment, the foundation will then sublease or otherwise grant rights to unitholders 103 in individual units 20 located in the fieldhouse facility 2. The foundation 101 may manage the fieldhouse facility 2 on a daily basis (or contract the same out), collect association fees, and generally operate as a property manager, lessor, or leasing agent with respect to the unitholders 103.

In a particular embodiment of the method that includes a foundation (whether or not non-profit or not-for-profit), the foundation 101 may contract with the unitholders 103 on the basis of an up-front payment, and possibly continuing fees (maintenance fees, association fees, renewal fees, and the like).

A particular embodiment of the method also includes a developer (which may also be a financer) 102. The duties that may be assigned to the developer include obtaining initial funding, loans, or financing of other sort (which may be absorbing the initial cost for reimbursement from receipts generated from contracts with unitholders 103), and arranging or coordinating or conducting construction. It should be recognized that in some cases a developer 102 and a foundation 101 may be related entities or may be the same entity.

Where an embodiment of the method includes an institution 100, a foundation 101, and a developer 102, the method may be undertaken in such a manner that the developer 102 is involved in the selection or proposal of site real estate 10. Developer 102 may in fact be the entity that generates the initial proposal, and “runs the numbers” to identify critical points such as minimum up front costs for individual units 20, and benefits to the institution 100. Developer may also establish the foundation 101 for the purposes of implementing this method, or may select or bid-out for involvement of existing foundations 101.

In such an embodiment (but not limited thereto), the inventors contemplate that the financing of the development may be arranged with some or all of the following characteristics, phases, or steps. The developer 102 (or other entity) calculates the financial arrangements necessary for the development of fieldhouse facilities to be financially advantageous. This typically will involve the computation of at least costs of construction, and projected revenue from up front costs associated with contracts for usage (referred to herein as “sales”, but which shall be understood to mean contracts for leasehold interests, rental or other use rights that do not convey fee simple title) of unit 20. The developer 102 (or other entity) proposes the development scenario to an institution 100 or to an existing foundation 101. The parties identify proposed site real estate 10. The details of the nature, term, and other aspects of the encumbrance of the site real estate 10 are selected. Prior to the completion of construction, or in most cases prior to the beginning of substantial construction, the proposed fieldhouse facility 2 is publicized and individual units 20 are place “on sale”, with the sales of the individual units 20 subject to the requirement that the sales are contingent upon a sales of individual units 20 meeting financially meaningful threshold. For example, it frequently may be a condition of the sales that no sale is final until the foundation 101 or developer 102 has received commitments for sales cumulating a certain dollar value, which may be set to equal or exceed the projected construction costs of the fieldhouse facility 2. Other thresholds could be number of units 20 sold, or even approvals from third parties. It is contemplated that the contingent sales would allow only the seller to take advantage of the contingency, not the purchaser (in other words, the purchaser is committed to finalize the sale if and only if the threshold is met).

Once the threshold is met, development is approved and additional contracts may be entered or finalized. Receipt of proceeds from sales of units 20 are allocated first to payment of charges and costs associated with construction and development (including professional fees) of fieldhouse facility 2. It is hoped that the proceeds from sale of units and perhaps other fees will exceed the development and construction costs associated with fieldhouse facility 2. In this case, the parties may have planned for a secondary improvement 3. The presence in the method of a secondary improvement 3 provides additional value to the institution, and can offset any depreciation or loss-of-use associated with the encumbrance on the site real estate 10. By way of example, secondary improvement 3 may be a structure to be located elsewhere on campus, such as a parking garage, dorm, instruction hall, or any other facility. Secondary improvement 3 need not be adjacent to fieldhouse facility 2. In fact, secondary improvement 3 may be located on land adjacent campus, such as site 4 on the map, or even on ex-campus land 5. Moreover, it is contemplated that in some embodiments of the method, secondary improvement 3 will be simply the acquisition of real estate adjacent campus or off-campus that will be contributed in title to the institution 100.

As noted above, the inclusion of secondary improvement 3 allows the institution to obtain a value from the method and its contributed encumbrance that is not limited to the location of the fieldhouse facility 2. In a particular embodiment of the method involving a secondary improvement 3, the proceeds from sales of units 20 that exceed the first threshold discussed above, or exceeds the costs of construction and development, may be allocated next to planning, construction, development, or purchase of the secondary improvement 3. This allocation can be limited to a maximum contribution, or may be terminated only when the secondary improvement 3 is completed or purchased. Additionally, the method can include an agreement among those involved that allows the developer to reduce the scale of the secondary improvement 3 if costs exceed expectations. The right of developer 102 to reduce the scale need not be absolute, as it could involve an option to the foundation 101 or the institution 100 to contribute funds to ensure that the original plan for the secondary improvement 3 is maintained. In any event the method may include safety provisions that prevent the developer 102 from being committed to develop the secondary improvement 3 at a loss. It should be noted that the secondary improvement 3 could be located on the same site real estate 10 as the fieldhouse facility 2. It may be attached or disconnected, or even a further improvement of the fieldhouse facility 2 like a parking structure or penthouse facilities provided for institution 100 use.

As will be seen, the fieldhouse facility 2 is constructed upon site real estate 10 that is retained by the institution 100 and merely encumbered for a measurable span of time. Upon expiration of the encumbrance, the institution 100 retains title to the site real estate 10 without encumbrance, which now also includes thereupon fieldhouse facility 2 as an improvement appurtenant to the land. The method contemplates that the institution 100 will enjoy fee title ownership of the fieldhouse facility 2 as an improvement to the land it owns at site real estate 10. Alternate embodiments could allow for buy-back requirements that would trigger a choice by the institution 100 to extend the term of the encumbrance or to pay a sum to obtain clear title to the fieldhouse facility 2. This is possible, but the inventors believe that the majority of implementations of the method will not require such a commitment by the institution 100, and will provide the fieldhouse facility 2 to institution 100 at the end of the term as a value added benefit. Likewise, variable conditions could be applied to the conveyance of the secondary improvement 3, but the inventors believe that most desirable would be outright transfer of fee simple title to the institution 100.

It is contemplated that the method could include the requirement that if the institution 100 will continue operation of the fieldhouse facility 2 after termination of the encumbrance that the unitholders 103 would have a right of first refusal to re-lease directly from the institution 100 (which right may be limited to their particular unit 20 in some embodiments).

Computers are critical in the analysis of the financial viability of the development, in the CAD engineering and design process, in determining the critical paths for scheduling the construction and marketing of the development, in monitoring the construction progress of the development and accounting for the costs incurred, in the analysis of unit sales, in the management of the facilities after completion (such as computing assessments, scheduling unit usage, devising and implementing scheduled maintenance procedures), in controlling physical access to the facilities during and after construction, and in fostering efficient communications among all of the parties involved in developing, constructing and operating the facilities.

In a variant of some of the embodiments of the method, the inventors contemplate that the units 20 will be sold in connection with a computerized bidding system. This system may be in the nature of an Internet accessible auction. Incentives to bidding can be provided. For example, the auction may provide that the highest bidder will have the first choice of units 20 to occupy, the second highest bidder will receive the second choice, and so forth. A similar system could be used in which the fifty (or other selected number) highest bidders receive some special preference (such as preference in selection of units, preferential parking, reduced association fees, choice of floor for their unit, or even build-out and finishing options not available to other bidders). Likewise, the bidding may be open or blind. In an open bidding system, it is contemplated that the knowledge of cost paid per unit may actually serve as incentive for competing bidders to raise the bid higher than they otherwise would.

Rules for occupancy of the fieldhouse facility 2 may be established in the method to ensure more value-added incentive to the institution 100. For example, the unitholder 103 may be required, as a condition of the sale, to forego occupancy except for a defined period of days around sporting events as listed on the institution's yearly sports calendar. Likewise, during non-occupancy times, the unitholder may be required to provide access and use to the unit 20 for housing, lecture, or other use by the institution 100. Moreover, the foundation 101 may be required to provide such access and use rights to the institution for all or designated “common areas” (such as exercise rooms, meeting rooms, club houses, community kitchens, and the like).

For purposes of security, and possibly compliance with the requirements of the grant-back rights listed in the preceding paragraphs, the access of unitholders 103 may be regulated by computerized security systems that coordinate with a database populated with the dates of sporting events on the institution calendar. Computers will also be used to assess fines for unpermitted usage, association fees, and other administrative functions.

The foregoing represents certain exemplary embodiments of the invention selected to teach the principles and practice of the invention generally to those in the art so that they may use their standard skill in the art to make these embodiments or other and variable embodiments of the claimed invention, based on industry skill, while remaining within the scope and practice of the invention, as well as the inventive teaching of this disclosure. The inventor stresses that the invention has numerous particular embodiments, the scope of which shall not be restricted further than the claims as issued. Unless otherwise specifically stated, applicant does not by consistent use of any term in the detailed description in connection with an illustrative embodiment intend to limit the meaning of that term to a particular meaning more narrow than that understood for the term generally. Moreover, stated advantages are exemplary and alternative, only, and should not be interpreted as required in all cases.

The figures shown are of illustrative embodiments, only. Notes, finishing, and measurements in such images are precise for such embodiments shown, but variation may be made as would be appreciable to one of ordinary skill in the art.

What is claimed is:

1. A method of developing on-campus facilities for institutions, comprising:
selecting a real estate parcel owned by the institution for construction of an improvement;
contracting with a developer for construction of the improvement;
leasing the improvement to a foundation for a limited time with an encumbrance on the real estate parcel for a limited time, where the encumbrance expires on a given expiration date and full title to the real estate parcel returns to the institution; and
subleasing the improvement to from the foundation to a sublessee.

2. The method of claim 1, where the improvement comprises a condominium.

3. The method of claim 1, where the improvement comprises a townhouse.

4. The method of claim 1, where the improvement comprises a multi-occupancy structure.

5. The method of claim 1, where the improvement comprises a parking facility.

6. The method of claim 5, where the parking facility comprises a covered parking area.

7. The method of claim 5, where the parking facility comprises a parking deck.

8. The method of claim 1, where the improvement comprises a meeting hall.

9. The method of claim 1, where the improvement comprises a stadium club.

10. The method of claim 1, where the developer selects the parcel of real estate.

11. The method of claim 1, where the developer raises funding for the construction of the improvement.

12. The method of claim 1, where the developer provides financial analysis of the improvement to the institution.

13. The method of claim 1, where the developer establishes the foundation.

14. The method of claim 1, where the encumbrance comprises air rights to the parcel of real estate.

15. The method of claim 1, where the encumbrance comprises underage rights to the parcel of real estate.

16. The method of claim 1, where the lease to the foundation allows the institution to use the improvement at designated times.

17. The method of claim 1, where the lease to the foundation allows the foundation to operate the improvement.

18. The method of claim 1, where the lease to the foundation allows the institution to buy out the lease early.

19. The method of claim 1, where the sublessee has rights of first refusal upon the expiration date of the encumbrance so that the sublessee my acquire rights to the improvement from the institution.

20. The method of claim 1, where the subleasing from the foundation is done by a computer based auction on the internet.

21. The method of claim 20, where computer based auction is conducted for an individual unit of the improvement.

22. The method of claim 20, where computer based auction is conducted based on availability dates for the improvement.

23. The method of claim 1, further comprising:
contracting with the developer to construct a secondary improvement.

24. The method of claim 23, where the secondary improvement is constructed on a separate real estate parcel from the improvement.

25. The method of claim 23, where the secondary improvement comprises an improvement to an existing facility owned by the institution.

26. The method of claim 23, where the secondary improvement comprises an additional parcel of real estate acquired for the institution.

27. A method of developing on-campus facilities for institutions, comprising:
selecting a real estate parcel owned by the institution for construction of an improvement;
contracting with a developer for construction of the improvement; and
leasing the improvement to a lessee for a limited time with an encumbrance on the real estate parcel for a limited time, where the encumbrance expires on a given expiration date and full title to the real estate parcel returns to the institution.
